(19) United States
(12) Patent Application Publication
(10) Pub. No.: US 2009/0281875 A1
(43) Pub. Date: Nov. 12, 2009

(54) TRAVEL RECOMMENDATIONS

(76) Inventor: Beatrice Tarka, San Francisco, CA (US)

Correspondence Address: PERKINS COIE LLP, P.O. BOX 1208, SEATTLE, WA, 98111-1208, US

(21) Appl. No.: 12/436,001

(22) Filed: May 5, 2009

Related U.S. Application Data
(60) Provisional application No. 61/050,597, filed on May 5, 2008.
(60) Provisional application No. 61/055,444, filed on May 22, 2008.

(51) Int. Cl. G06Q 30/00; G06F 17/30; G06Q 50/00; G06Q 99/00; G06F 17/40

(52) U.S. Cl. 705/10; 707/5; 705/1; 707/E17.014; 707/E17.044

(57) ABSTRACT

A system for recommending travel receives traveler trip data including both previously collected information and dynamically collected information. The system uses a traveler's trip information to produce recommendations the traveler. These recommendations are prioritized and then several top recommendations are presented to the traveler for purchase.

### RELATED APPLICATIONS

This application claims priority to U.S. Provisional Patent Application No. 61/050,597, filed May 5, 2008, and entitled “SYSTEM AND METHOD FOR GENERATING USER ACTIVITY-BASED TRAVEL RECOMMENDATIONS” by Beatrice Tarka, which is incorporated herein by reference.

This application claims priority to U.S. Provisional Patent Application No. 61/055,444, filed May 22, 2008 and entitled “SYSTEM AND METHOD FOR GENERATING USER ACTIVITY-BASED TRAVEL RECOMMENDATIONS” by Beatrice Tarka, which is incorporated herein by reference.

### BACKGROUND

A travel portal services travelers by offering travel arrangements in response to searches travelers provide. The travel portal can be, e.g. a website linked to airlines, hotels, and other travel service providers.

Travelers often use travel portals to reduce the cost of travel over the prices offered by travel service providers. Travel service providers benefit by the increased exposure to travelers and have the opportunity to selectively discount fares and rates based on arrangements with travel portals. Such travel arrangements can be referred to as partnerships between the travel portal and the travel service providers.

When searched, the travel portal can query databases for pricing information from the travel service providers. The travel portal can assemble vacation packages including various fares, and rates and present the packages to travelers with corresponding offer prices.

Often when searching a travel portal for various criteria, travelers may not receive the lowest price that is acceptable to them given such limitations of, e.g. date, geographic locations to be traveled, and attractions at the various locations.

For example, a traveler might search for a flight leaving Friday, but in fact be willing to travel Saturday, missing a 20% discounted fare leaving the next day. Alternatively, the traveler may search for travel to Honolulu and Cancun, but not Miami even though the traveler really wants a beach vacation within a half a day's flight.

If the travelers were presented recommendations for their travel that corresponded with their desires rather than merely their search criteria then the travelers would be more satisfied and the travel portal would experience a higher rate of business. However, existing travel portals do not provide such traveler specific recommendations.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

A system for recommending travel receives traveler trip data including both previously collected information and dynamically collected information.

For example, such data can include traveler profiles, traveler past purchasing behavior, current and/or recent travel search queries, social network information regarding previous travel by friends of the traveler, context information inferred or dynamically gathered from the traveler at the time of search, and other known or convenient traveler trip data.

The system then uses the traveler trip information to produce recommendations for traveler travel. The system then prioritizes the travel using business rules in order from most likely to be accepted through least likely to be accepted.

Then top recommendations are presented to a traveler for purchase.

### BRIEF DESCRIPTION OF THE DRAWINGS

FIG. 1 depicts an example of a system for offering travel to a traveler through a travel portal.

FIG. 2 depicts components of a system for recommending travel.

FIG. 3 depicts an example of a flowchart for recommending travel.

FIG. 4 depicts an example of a system representative of computing systems discussed herein.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

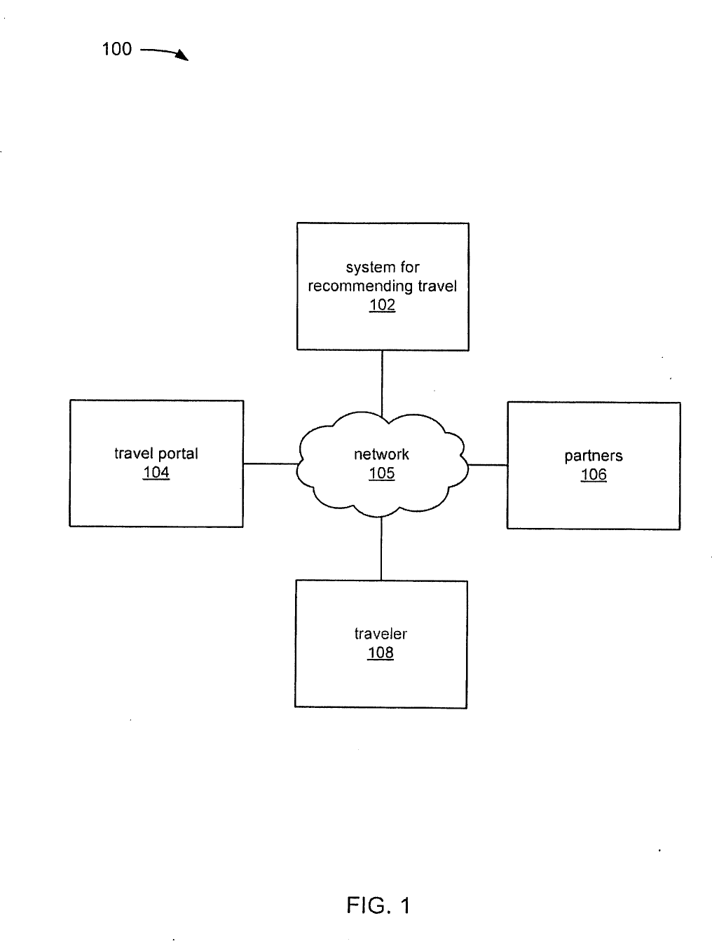

FIG. 1 depicts an example of a system for offering travel to a traveler through a travel portal. FIG. 1 includes a system for recommending travel 102, a travel portal 104, network 105, partners 106, and traveler 108.

In the example of FIG. 1, system for recommending travel 102 includes various engines and data repositories for managing information regarding a traveler. The system for recommending travel 102 can collect data on the traveler's travel habits, partner offerings, and other known or convenient travel data. The engines can process this data and produce recommendations for travel.

In the example of FIG. 1, travel portal 104 can be an interface, website or other known or convenient communications system for purchasing travel. For example, the travel portal 104 can be a website offering various airline and hotel reservations. Alternatively, the travel portal 104 can be an interface such as a command line interface system, e.g. the SABRE computing system for offering airline reservations. Further, the interface can be any other known or convenient interface for reserving travel.

In the example of FIG. 1, the network 105 can be a networked system that includes several computer systems coupled together, such as the Internet.

As used in this paper, a network, such as network 105, can include The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed the network 105 broadly includes, as understood from relevant context, anything from a minimalist coupling of the components illustrated in the example of FIG. 1, to every component of the Internet and networks coupled to the Internet.

In the example of FIG. 1, partners 106 can be hotels, airlines, travel portals, websites, companies, vacation rental managers, timeshares and other known or convenient providers of travel services.

In the example of FIG. 1, traveler 108 can be a computing system used by an individual, couple, family, group, or other person or persons. Traveler 108 supplies queries, and data on behalf of the individual(s) traveling. For example, traveler 108 can supply a number of persons traveling, travel times and dates, desired locations and other information used to make recommendations to the traveler 108 for travel services.

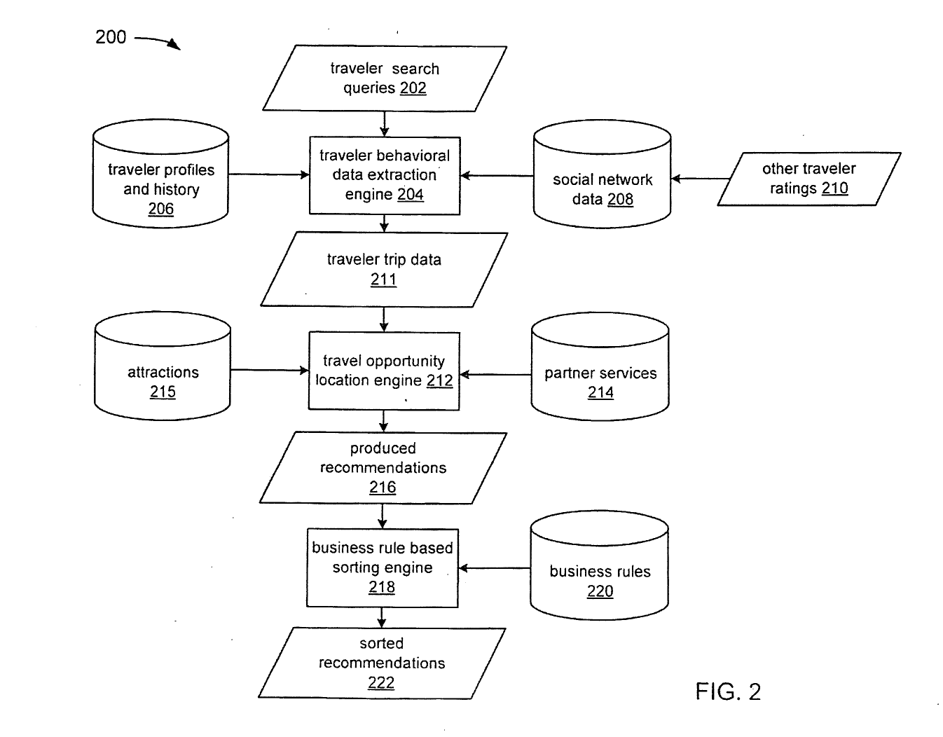

FIG. 2 depicts components of a system for recommending travel. FIG. 2 includes traveler search queries 202, traveler behavioral data extraction engine 204, traveler profiles and history repository 206, social network data repository 208, other traveler ratings 210, traveler trip data 211, travel opportunity location engine 212, partner services 214, attractions 215, produced recommendations 216, business rule based sorting engine 218, business rules 220, and sorted recommendations 222.

In the example of FIG. 2, traveler search queries 202 can include data such as travel dates, travel times, number of persons traveling, destination and origination locations, and any other known or convenient travel data. Search queries 202 can be gathered from a traveler at a travel portal, such as a travel portal 104, as is discussed in reference to FIG. 1.

In the example of FIG. 2, traveler behavioral data extraction engine 204 interprets traveler search queries in light of stored traveler profiles and history data. For example, when entering a search for a trip from California to Spain, the airports, e.g. SFO (San Francisco International Airport) and BCN (Aeropuerto de Barcelona) can be extracted from the search query and interpreted as indicating a desire to make a trip to Europe. Further, additional information such as the traveler's internet protocol (IP) address can be gathered and correlated with a geographic location to identify data such as a location of origination of a trip at the time of search, e.g., the traveler can be identified as having an IP in San Jose, and flights originating from SJC to BCN can be recommended to the traveler as well as flights originating at SFO.

Further, attractions can be factored into the interpretations made by traveler behavioral data extraction engine 204. As used herein, “attractions” or “tourist attractions” are destinations that travelers visit. For example, an attraction need not be a specific geographic location, and could be broad, e.g. Europe can be an attraction. Similarly attractions need not be in close geographic proximity to each other; “the beach” could be an attraction describing locations including Miami, Hawaii, and Mexico's Baja Yucatan peninsula. Alternatively, an attraction can be a specific location or business, such as Disneyland in Anaheim, Calif. Further, an attraction can be any known or convenient destination for travel.

Notably, attractions can be identified or interpreted from a traveler's search by considering the various locations that a traveler is searching for in light of the traveler's previous searches and data known about the traveler.

As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. As used herein an engine can include software implemented on hardware.

In the example of FIG. 2, traveler profiles and history repository 206 can store data gathered from a traveler whether directly or indirectly from the traveler's searches and past purchasing decisions. Various data can be gathered. For example, where a traveler consistently requests two seats of airfare, it can be interpreted that the traveler is purchasing airfare for a couple. Alternatively, where a traveler signs up with a travel portal various pieces of information, e.g. demographic information and residence information, these pieces of information can be gathered from the traveler. Further, any known or convenient information can be gathered from the traveler.

As used in this paper, a repository can be implemented, for example, as software embodied in a physical computer-readable medium on a general- or specific-purpose machine, in firmware, in hardware, in a combination thereof, or in any applicable known or convenient device or system. The repositories described in this paper are intended, if applicable, to include any organization of data, including trees, tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 2, social network data repository 208 stores information gathered from individual identified as friends of the traveler as well as opinions the friends have of various travel services and attractions. It can be presumed that the traveler's friends will have similar preferences as the traveler herself. With this information a recommendation that would otherwise be found negative for the general population may be found positive for the particular individual. Similarly, popular destinations that are shunned by a particular group may be avoided when recommending destinations to a particular traveler. Further, group opinions can otherwise be used to recommend travel to individuals.

In the example of FIG. 2, other traveler ratings 210 can include ratings provided by friends of the traveler. The ratings can be collected and stored into the social network data repository 208.

In the example of FIG. 2, traveler trip data 211 can include traveler profile information, search query data, social network data, context information, past purchasing behavior, and any other known or convenient information.

As used herein, “context information” is used to refer to information interpreted from traveler search queries and other readily gathered data. For example, context information can include the traveler's most likely location as interpreted above from the IP address and departure location. Alternatively, the context information can include a desired destination, e.g. South America such as where the traveler searches in three different South American cities with no apparent correlation other than the general geographic region. Further, the attraction can be the basis for the search, such as where a traveler searches for travel to Vail, Colo., Whistler, British Columbia, and Mammoth, Calif. it can be inferred that the traveler is seeking a ski vacation. Further any known or convenient combination of traveler data points can be used to correlate the context in which the traveler is searching.

Such context information can be used where it appears consistent, however, where apparently unreliable, such information can be ignored. For example, where the traveler is departing from a location in California, but sending queries from a computer having an IP address located in Ohio.

In the example of FIG. 2, travel opportunity location engine 212 searches attractions and partner services for travel services that will satisfy the traveler trip data. Each combination of travel services and attractions will generate a slightly different travel opportunity for a traveler.

In the example of FIG. 2, partner services 214 include data describing various travel services offered by a travel portal on behalf of the partners. For example, the partner services repository 214 can include data on flights, hotels, trains, vacation rentals, vacation packages, dining, theme parks, rental cars, entertainment, and any known or convenient travel service or combination of travel services.

In the example of FIG. 2, attractions 215 include data describing locations offering, e.g. beaches, theme parks, skiing, sailing, scenery, and any other known or convenient attraction.

In the example of FIG. 2, produced recommendations 216 include search results of defining travel services and/or combination of travel services. The produced recommendations can be disordered, such as in a random pattern from the searching process.

In the example of FIG. 2, business rule based sorting engine 218 can receive a list of recommendations for sorting from best to worst recommendation.

In the example of FIG. 2, business rules 220 can include a collection of constraints, settings, setting, controls, and other decision making factors used to order the recommendations from best to worst. The business rules can be varied across groups of travelers or held constant as is desirable.

In the example of FIG. 2, sorted recommendations 222 are recommendations to be presented to travelers for selection. For example, the top for recommendations can be displayed as text, images, or a combination thereof in a web portal. Alternatively, the recommendations can be displayed, transmitted or otherwise communicated to the traveler as is known or convenient.

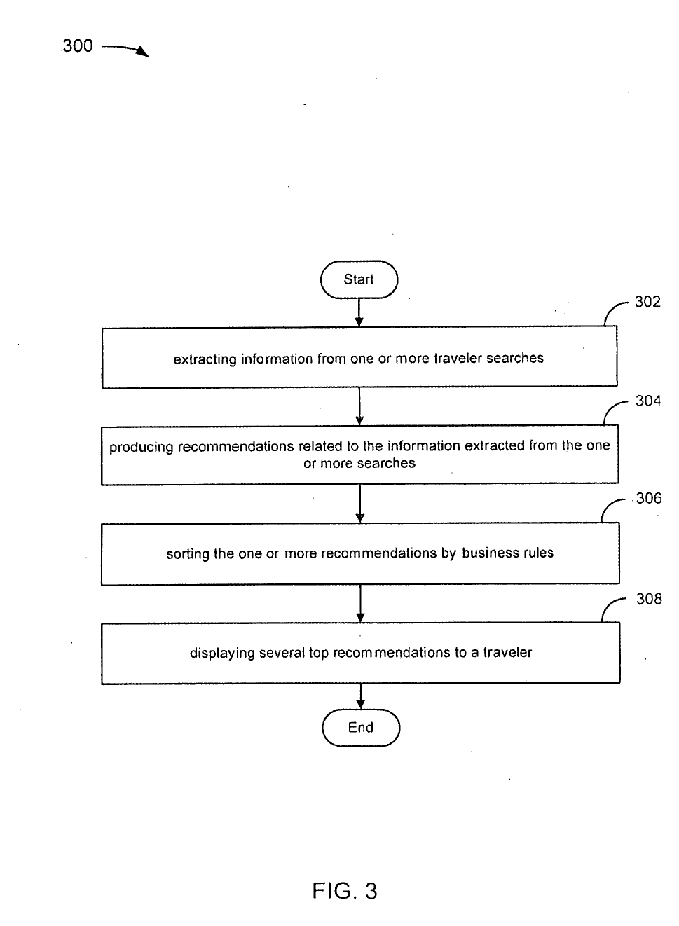

FIG. 3 depicts an example of a flowchart for recommending travel. The flowchart 300 is organized as a sequence of modules. However, it should be understood that these and modules associated with other methods described herein may be reordered for parallel execution or into different sequences of modules.

In the example of FIG. 3, the flowchart starts at module 302 with extracting information from one or more traveler searches. For example, where a traveler searches for flights from San Francisco to Tokyo the airports can be extracted from the search and saved as data for later use. Additionally, where the traveler searches for availability of hotels in, for example, Seoul, Korea with September dates of travel, the city can be extracted along with the dates, as a potential travel destination on potential travel dates. Further, any known or convenient data point can be extracted from a traveler's search.

The data can be used to infer information. For example, when entering a search for a trip from New York to Greece, various hotels selected by the traveler can be considered terms of relative quality. If the traveler selects only 4 star hotels, it can be inferred that a 2 star hotel might not be acceptable to the traveler. Similarly if the traveler is contemporaneously searching for the Parthenon and the Acropolis it can be inferred that the traveler is interested in visiting Athens, Greece. Further, any known or convenient data point can be used to interpret information from a traveler's search. Collectively, the data extracted from the search queries and inferred from the extracted data can be saved as traveler trip data.

In the example of FIG. 3, the flowchart continues to module 304 with producing recommendations related to the information extracted from the one or more searches. The recommendations can be created by relating attractions and partner services to traveler trip data.

In the example of FIG. 3, the flowchart continues to module 306 with sorting the one or more recommendations by business rules. Various combinations of travel services and attractions can generate slightly different travel opportunities for a traveler. and the various recommendations can be sorted by business rules to provide the best recommendations to the traveler based on the data gathered from the traveler. The business rules can take into account the traveler's profile and past purchasing history.

In the example of FIG. 3, the flowchart continues to module 308 with displaying several top recommendations to a traveler. The top recommendations can be displayed to the traveler, e.g. a travel portal could have a dedicated space for displaying the top four or top three recommendations. As a traveler searches through various options, the recommendations can change. Having displayed top recommendations to a traveler the flowchart terminates.

The system 400 may be a conventional computer system that can be used as a client computer system, such as a wireless client or a workstation, or a server computer system. The system 400 includes a device 402, I/O devices 404, and a display device 406. The device 402 includes a processor 408, a communications interface 410, memory 412, display controller 414, non-volatile storage 416, I/O controller 418, clock 422, and radio 424. The device 402 may be coupled to or include the I/O devices 404 and the display device 406.

The device 402 interfaces to external systems through the communications interface 410, which may include a modem or network interface. It will be appreciated that the communications interface 410 can be considered to be part of the system 400 or a part of the device 402. The communications interface 410 can be an analog modem, ISDN modem or terminal adapter, cable modem, token ring IEEE 802.4 interface, Ethernet/IEEE 802.3 interface, wireless 802.11 interface, satellite transmission interface (e.g. “direct PC”), WiMAX/IEEE interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 408 may be, for example, a conventional microprocessor such as an Intel Pentium microprocessor or Motorola power PC microprocessor. The memory 412 is coupled to the processor 408 by a bus 420. The memory 412 can be Dynamic Random Access Memory (DRAM) and can also include Static RAM (SRAM). The bus 420 couples the processor 408 to the memory 412, also to the non-volatile storage 416, to the display controller 414, and to the I/O controller 418.

The I/O devices 404 can include a keyboard, disk drives, printers, a scanner, and other input and output devices, including a mouse or other pointing device. The display controller 414 may control in the conventional manner a display on the display device 406, which can be, for example, a cathode ray tube (CRT) or liquid crystal display (LCD). The display controller 414 and the I/O controller 418 can be implemented with conventional well known technology.

The non-volatile storage 416 is often a magnetic hard disk, flash memory, an optical disk, or another form of storage for large amounts of data. Some of this data is often written, by a direct memory access process, into memory 412 during execution of software in the device 402. One of skill in the art will immediately recognize that the terms “machine-readable medium” or “computer-readable medium” includes any type of storage device that is accessible by the processor 408.

Clock 422 can be any kind of oscillating circuit creating an electrical signal with a precise frequency. In a non-limiting example, clock 422 could be a crystal oscillator using the mechanical resonance of vibrating crystal to generate the electrical signal.

The radio 424 can include any combination of electronic components, for example, transistors, resistors and capacitors. The radio is operable to transmit and/or receive signals.

The system 400 is one example of many possible computer systems which have different architectures. For example, personal computers based on an Intel microprocessor often have multiple buses, one of which can be an I/O bus for the peripherals and one that directly connects the processor 408 and the memory 412 (often referred to as a memory bus). The buses are connected together through bridge components that perform any necessary translation due to differing bus protocols.

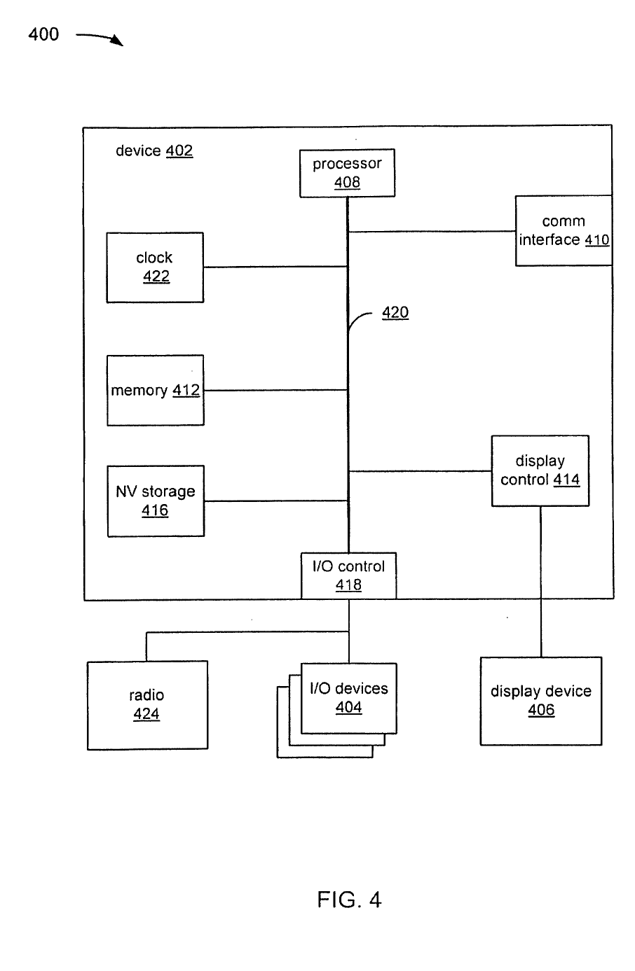

Network computers are another type of computer system that can be used in conjunction with the teachings provided herein. Network computers do not usually include a hard disk or other mass storage, and the executable programs are loaded from a network connection into the memory 412 for execution by the processor 408. A Web TV system, which is known in the art, is also considered to be a computer system, but it may lack some of the features shown in FIG. 4, such as certain input or output devices. A typical computer system will usually include at least a processor, memory, and a bus coupling the memory to the processor.

In addition, the system 400 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 416 and causes the processor 408 to execute the various acts required by the operating system to input and output data and to store data in memory, including storing files on the non-volatile storage 416.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

It will be appreciated to those skilled in the art that the preceding examples are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of these teachings.

What is claimed is:

1. A system for recommending travel options comprising:
a traveler behavioral data extraction engine;
a travel opportunity location engine coupled to the traveler behavioral data extraction engine;
a partner services repository coupled to the travel opportunity location engine;
an attractions repository coupled to the travel opportunity location engine;
a business rule based sorting engine coupled to the travel opportunity engine; and
a business rules repository coupled to the business rule based sorting engine;
wherein in operation,
the traveler behavioral data extraction engine processes traveler search queries to produce traveler behavioral data;
the travel opportunity location engine produces travel recommendations based on traveler trip data, partner services data from the partner services data repository and attractions data from the attractions repository; and
the business rule based sorting engine sorts the recommendations in order according to the business rules included in the business rules repository.

2. The system of claim 1 wherein the sorted recommendations are provided to a travel portal for display of several best recommendations.

3. The system of claim 1 wherein the attractions repository receives additional data describing a new attraction.

4. A method for recommending travel comprising:
extracting information from one or more traveler searches;
producing recommendations related to the information extracted from the one or more searches;
sorting the one or more recommendations by business rules; and
displaying several top recommendations to a traveler.

5. The method of claim 3 further comprising inferring a traveler location from an IP address and an origination airport.

6. The method of claim 3 further comprising storing social network data associated with friends of the traveler in association with the traveler.

7. The method of claim 3 further comprising storing partner services information into a partner services repository.

8. The method of claim 6 further comprising receiving the partner services information from a partner electronically from a partner who volunteers the information regarding the partner services.
